(19) United States
(12) Patent Application Publication
(10) Pub. No.: US 2010/0022698 A1
(43) Pub. Date: Jan. 28, 2010

(54) SIZED GLASS STRANDS INTENDED FOR REINFORCEMENT OF POLYMER MATERIALS, PARTICULARLY IN MOLDING

(76) Inventors: Dino Lombino, La Motte Servolex (FR); Francois Roederer, Chambery (FR); Claire Metra, Challes Les Eaux (FR)

Correspondence Address: OWENS CORNING, 2790 COLUMBUS ROAD, GRANVILLE, OH, 43023, US

(21) Appl. No.: 12/297,107

(22) PCT Filed: Apr. 6, 2007
(86) PCT No.: PCT/FR2007/051082

§ 371 Date: Aug. 18, 2009

(30) Foreign Application Priority Data
Apr. 12, 2006 (FR) 0651333

(51) Int. Cl. C08K 3/40; C08L 39/04

(52) U.S. Cl. 524/494; 525/203

(57) ABSTRACT

The invention relates to glass strands intended for the reinforcement of polymer materials which are coated with a sizing composition comprising, as adhesive film-forming agents, the blend of at least one polyvinyl acetate and at least one polyvinylpyrrolidone, said at least polyvinyl acetate representing 70 to 90% by weight of the solid matter of the size.

The glass strands obtained are used as reinforcements in the manufacture of molded parts having a thermosetting matrix obtained by the technique of spray-up molding of said strands and resin, especially by LFI (Long Fiber Injection) molding.

The invention relates to glass strands coated with a sizing composition that are intended for reinforcing organic materials of the polymer type, to the sizing composition used to coat said strands and to the composites thus obtained, especially by molding,

The glass strands used for reinforcement are generally produced on an industrial scale from streams of molten glass flowing out of the many orifices in a bushing. These streams are mechanically drawn in the form of continuous filaments, then they are gathered together into base strands that are then collected, for example by winding onto a rotating support. Before they are gathered together, the filaments are coated with a sizing composition by passing them over a suitable device such as coating rolls.

The sizing composition proves to be essential on several counts.

During manufacture of the reinforcing strands, the sizing composition protects the glass filaments from abrasion that occurs when they rub at high speed against the various members used for guiding and collecting them. It also establishes bonds between the filaments thereby providing the strand with cohesion. Since the strand has been made more integral, it is easier to handle it, especially during weaving operations, and inopportune breakages are avoided.

During the manufacture of composites, the sizing composition promotes wetting and impregnation of the glass strands with the matrix to be reinforced, this matrix generally being used in the form of a relatively fluid resin. The mechanical properties of the final composite are therefore substantially improved.

The materials to be reinforced may incorporate the glass strands in various forms: continuous or chopped strands, continuous or chopped strand mats, fabrics, etc.

Composites that incorporate chopped glass strands may be obtained, amongst other ways, by the technique of “spray-up molding” which consists in spraying a resin to be reinforced and glass strands of variable length into the inside of a mold. The stands and the resin are sprayed together onto the internal walls of the mold by means of a “gun” that includes an incorporated chopper capable of cutting the strands extracted from one or more packages and a device for spraying the resin. This process, which is simple and can be modulated, is particularly suitable for the production of one-off or short-run parts based on thermosetting polymers belonging to the family of polyesters or epoxides.

A particular technique for manufacturing composites by spray-up molding is known under the name “long fiber injection” (LFI). This consists in simultaneously spraying, into a mold, chopped strands at high speed (around 300 to 1200 meters per minute) in cycles lasting a few tens of seconds, and reactive monomers capable of creating a resin by curing, and in then applying a countermold. This technique is particularly suitable for producing parts made of polyurethane, especially for an automotive vehicle, for example interior door linings, parcel shelves, instrument panels and roofs.

The quality of the composites obtained by these processes largely depends on the properties provided by the glass strands, and therefore on the size that coats them and on the processing conditions. In particular, sizing compositions are sought that enable a strand to be obtained which may be extracted from a package, for example a cake or a roving, while forming the least amount of loops possible and which keeps its integrity after cutting.

The formation of loops is not desired for the following reasons:
firstly, the loops hamper the passage of the strand inside the flexible arm which is used to cut and to spray said strand into the mold. Poor operation of the chopper results which does not deliver a constant amount of chopped glass into the mold;
then, the high stress of the strand during the start up of each cutting cycle causes the “filamentization” of the strand at the loops, that is to say breaking of the filaments constituting the strand, together with the production of “fuzz” which accumulates in various parts of the process. By detaching itself from the chopper, the fuzz forms clusters in the resin which damage the quality of the molded part.

In either case, production is decreased due to the stops required to clean the soiled members.

It is also desired that the integrity of the strand remains at a high level in order that it does not “open” by separating the filaments that constitute it during the start up of each cutting cycle where the tension on the strand is high. But it is also necessary that the filaments remain linked together after cutting so that the chopped strand may fulfill its role of reinforcing the matrix in the final part.

The improvement of these properties should not be carried out to the detriment of other properties. In particular, it is important that the strand has “slip” so that it can be easily unwound or paid out from the package without high tension that risks damaging the strand, while still having a sufficient stiffness so that it can be chopped under good conditions.

It is also necessary that the chopped strand can be rapidly impregnated by the precursor monomers of the resin and that the mixture obtained be homogenous and uniformly distributed in the mold, without “collapsing” under gravity.

Sized glass strands suitable for these spray-up molding techniques are already known,

In EP-A-0 869 927, glass strands are described that are coated with a sizing composition comprising, as adhesive film-forming agents, the combination of at least one polyvinyl acetate A of low molecular weight and at least one thermally self-crosslinkable vinyl acetate copolymer B in an A/B weight ratio greater than or equal to 1. These strands have a high rate of impregnation by the resin.

In WO-A-02/059055, the glass strands are coated with an essentially aqueous sizing composition that comprises at least one bis-silane A and at least one unsaturated monosilane B chosen from vinyl silanes and methyl (acrylosilanes). The size allows the lifetime of the chopper blades to be increased. The rate of impregnation of the strands is high.

In FR-A-2 279 688, the glass strands are coated with a sizing product comprising an aqueous mixture based on polyvinyl acetate, a lubricant based on a fatty acid, methacrylato chromic chloride and γ-(ethylene diamine) propyltrimethoxysilane.

Although the performance level of these strands is overall satisfactory, the number of loops per unit length of strand remains high and the integrity is insufficient.

The object of the present invention is to provide a reinforcing glass strand, especially intended for spray-up molding, in particular molding by LFI, which forms few loops when it is extracted from a package and which has a better integrity than the known strands suitable for this type of molding.

One subject of the invention is a glass strand coated with an aqueous sizing composition which comprises, as adhesive film-forming agents, the blend of at least one polyvinyl acetate and at least one polyvinylpyrrolidone.

In the present invention, the term “glass strands coated with a sizing composition which comprises . . . ” is understood to mean not only glass strands coated with the composition in question, such as those obtained immediately on leaving the sizing device or devices, but also these same strands after they have undergone one or more other treatments. By way of example, mention may be made of the drying operations intended for removing the liquid phase from the composition and the treatments resulting in the curing/crosslinking of certain constituents of the sizing composition.

Still within the context of the invention, the term “strands” should be understood to mean the base strands resulting from gathering together a multitude of filaments beneath the bushing, and the products derived from these strands, especially assemblies of these base strands in the form of rovings. Such assemblies may be obtained by simultaneously paying out from several wound packages of base strands and then by gathering them together into rovings that are wound onto a rotating support. Assemblies may also be “direct” rovings having a linear density (or mass per unit length) equivalent to that of the assembled rovings, obtained by gathering together the filaments directly beneath the bushing and winding them onto a rotating support.

Also according to the invention, the term “aqueous sizing composition” is understood to mean a sizing composition in the form of a solution in which the liquid phase is formed from 97%, preferably 99% and better still 100%, by weight of water, the remainder being formed, if necessary, from one or more essentially organic solvents which may help to dissolve certain constituents of the sizing composition. Generally, the sizing composition incorporates 85 to 95%, preferably 89 to 94%, by weight of water.

According to the invention, the sizing composition comprises, as adhesive film-forming agents, the blend of at least one polyvinyl acetate and at least one polyvinylpyrrolidone.

The polyvinyl acetate is important for rapidly achieving a high level of impregnation of the strands by the resin and for obtaining good conformability of the strand/resin mixture in the mold. The polyvinyl acetate also provides the strand with stiffness.

The molecular weight of the polyvinyl acetate is generally less than or equal to 80 000 g/mol, preferably less than or equal to 70 000 g/mol and preferably is between 29 000 and 65 000 g/mol. The amount of polyvinyl acetate generally represents 70 to 90%, preferably 75 to 85%, by weight of the solid matter of the size deposited on the strand.

The polyvinylpyrrolidone is involved in bonding the glass filaments, thus making it possible to increase the integrity of the strand after chopping, and in addition enables the tack of the strand to be adjusted and the ability of the strand to form loops to be reduced.

The molecular weight of the polyvinylpyrrolidone is generally less than or equal to 4000 g/mol, preferably less than or equal to 3000 g/mol, and advantageously between 1000 and 2000 g/mol.

In the size, the amount of polyvinylpyrrolidone is such that the polyvinyl acetate/polyvinylpyrrolidone weight ratio varies from 14 to 900, preferably from 18.75 to 106.25.

In addition to the aforementioned components that are essentially involved in the structure of the size, the sizing composition may comprise one or more other components (hereinafter denoted by “additives”).

The sizing composition may thus comprise at least one plasticizer which has the role of making the polymer chains of the adhesive film-forming agents more flexible. By helping to lower the glass transition temperature of the adhesive agents, the plasticizer makes it possible to obtain a better “conformability” of the chopped strands/resin mixture in a mold of complex shape. In general, the plasticizer is chosen from glycol derivatives such as alkylene glycol dibenzoates, preferably ethylene and/or propylene glycol dibenzoates.

The amount of plasticizer in the size depends on the degree of flexibility that it is desired to give the strand, it being understood that the strand must be sufficiently rigid for it to be correctly distributed within the resin. Generally, the plasticizer represents 6 to 20% by weight of the solid matter of the size.

The composition may also comprise at least one lubricant in an amount representing from 3 to 9% by weight of the solid matter of the sizing composition. Besides the role of protecting the filaments against mechanical abrasion, the lubricant helps to limit the formation of fuzz and to prevent the turns from sticking to the base strand packages.

In general, these agents are chosen from cationic compounds of the polyalkyleneimide type and ionic compounds of the fatty acid and polyalkylene glycol polyoxyalkylene ester type, such as polyethylene glycol monolaurate, or of the fatty acid and polyoxyalkylene amide type such as hydrogenated tallow and polyethylene amides.

The sizing composition may also comprise at least one coupling agent that allows the size to be bonded to the surface of the glass filaments. The coupling agent is generally chosen from silanes such as γ-glycidoxypropyltrimethoxysilane, γ-acryloxypropyl-trimethoxysilane, γ-methacryloxypropyltrimethoxysilane, poly(oxyethylene/oxypropylene)trimethoxysilane, γ-aminopropyltriethoxysilane, vinyltrimethoxysilane, phenylaminopropyltrimethoxysilane, or styrylaminoethyl-aminopropyltrimethoxysilane, siloxanes, titanates, zirconates and mixtures of these compounds.

Preferably, silanes are chosen.

The amount of coupling agent generally represents less than 7%, preferably is greater than 2% and most often is around 5%, by weight of the solid matter of the sizing composition.

The size may also comprise at least one antistatic agent that helps to improve the ability of the glass strand to be chopped up. The antistatic agent is chosen from metal salts such as lithium chloride. The amount of antistatic agent generally represents at most 5% by weight of the solid matter of the size.

All these additives help to obtain reinforcing strands which can be easily manufactured, which may be extracted without difficulty from packages with a reduced number of loops and which may be chopped without any problem and sprayed into a mold while retaining good integrity.

The strand according to the invention may undergo an additional step that aims to coat it with an additional size (“oversize”) with the objective of giving it a better slip and of reducing the level of electrostatic charge to give the strand a better ability to be chopped up. The application of an oversize proves advantageous in the case where the sizing composition does not include any antistatic agent. The oversize then comprises, as antistatic agent, at least one quaternary ammonium salt. As a general rule, the amount of oversize represents 0.02 to 0.2%, preferably 0.05 to 0.10%, of the weight of the strand,

The glass strand coated with the sizing composition according to the invention has a loss on ignition less than 3%, preferably less than or equal to 2%. Advantageously, the loss on ignition is greater than 1.25% and better still is between 1.3 and 1.7%.

Most often, the glass strands according to the invention are in the form of base strand packages that are subjected to a heat treatment. This treatment is essentially intended for removing the water supplied by the sizing composition and, where appropriate, allows crosslinking of the adhesive film-forming agents to be accelerated. The treatment conditions may vary depending on the weight of the package. In general, drying is carried out at a temperature of around 110 to 140° C. for several hours, preferably 12 to 18 hours.

The strands coated with the sizing composition according to the invention may be formed from glass of any type provided that it is capable of being fiberized, for example E-glass, C-glass, AR (alkali resistant)-glass, or glass having a low boron content (less than 5%).

The same strands are formed from filaments whose diameter may vary over a wide range, for example 10 to 20 μm, preferably 11 to 16 μm. Advantageously, these strands have a linear density between 30 and 200 tex, preferably between 50 and 160 tex.

Another subject of the invention relates to the aqueous sizing composition able to coat said glass strands, which composition is characterized in that it comprises the constituents below, in the following weight contents expressed as percentages of solid matter:
70 to 90%, preferably 75 to 85%, of at least one polyvinyl acetate;
0.1 to 5%, preferably 0.8 to 4%, of at least one polyvinylpyrrolidone;
6 to 20%, preferably 7 to 15%, of at least one plasticizer;
3 to 9%, preferably 3.5 to 6.5%, of at least one lubricant;
2 to 7%, preferably 3.5 to 6%, of at least one coupling agent; and
0 to 5% of at least one antistatic agent.

Preferably, the sizing composition comprises between 5 and 15%, preferably between 6 and 14% and better still between 8 and 12%, by weight of solid matter.

The sizing composition is prepared by simple mixing of the aforementioned constituents and water. When the coupling agent is a silane, this silane has first undergone a hydrolysis step in the presence of an acid.

Another subject of the invention relates to the composites comprising the glass strands coated with the sizing composition. Such composites comprise at least one thermosetting material, preferably a polyester, a vinyl ester, an acrylic polymer, a polyurethane, a phenolic resin or an epoxy resin, and glass strands formed, completely or partly, from glass strands according to the invention.

The glass content within the composite is generally between 20 and 45%, and preferably between 25 and 35%, by weight.

Another subject of the invention is the use of the glass strands coated with the sizing composition for producing composite parts by the technique of spray-up molding, especially by the LFT technique.

The following example allows the invention to be illustrated without however limiting it.

The properties relating to the glass strands coated with the sizing composition were measured as follows:
the loss on ignition, as a percentage, of the sized glass strand was measured under the conditions of the ISO 1887 standard;
the number of loops was measured by paying out the strand from a roving, over a length of 500 meters, and by making it pass between two optical sensors that detect defects. The number of loops was given per kg of strand;
the fuzz was measured by making 0.5 kg of strand paid out from a roving pass over a turn roll, at a speed of 80 m/min, and by determining the mass of fibrils generated during the passage. The fuzz is given in mg/kg of strand;
the half-charge decay time (in seconds) was calculated from measurements of the electric field obtained using a static voltmeter, on the strand placed in a static chamber at 20° C. and 20% relative humidity;
the integrity of the strand was measured by unwinding the strand into a WOLFANGEL chopper at a rate of 1200 m/min, without chopping it, and by observing the appearance of the strand according to the scale of values ranging from 1=poor, strand not integrated, individual base strands, to 5=very good, integrated strand;
the integrity of the strand after chopping was measured in the following way: the strand paid out from a roving was introduced into a WOLFANGEL 500 chopper that chopped it and sprayed it substantially horizontally onto a vertical wall (chopping rate: 1200 m/min; length: 12 mm) The integrity of the chopped strand was assessed visually according to the following scale of values: 1=poor, cottony appearance; 3=average, “hair” appearance; 5=very good, no fluffing of the strand.

### EXAMPLE

A sizing composition was prepared in the form of an aqueous solution comprising, as weight percentage of solid matter:

adhesive film-forming agents:

| | |
|---|---|
| polyvinyl acetate; molecular weight: 50 000⁽¹⁾ | 80 |
| polyvinylpyrrolidone; molecular weight: 1200-2000⁽²⁾ | 3.75 |

coupling agents:

| | |
|---|---|
| γ-methacryloxypropyltriethoxysilane⁽³⁾ | 1 |
| aminosilane⁽⁴⁾ | 4 |

plasticizer:

| | |
|---|---|
| mixture of diethylene glycol dibenzoate and | 7.45 |
| dipropylene glycol dibenzoate (50/50 weight ratio)⁽⁵⁾ | |

lubricants:

| | |
|---|---|
| polyethyleneimide having free amide functional groups⁽⁶⁾ | 3.8 |

water:

quantity sufficient to give 100 ml of sizing composition.

The sizing composition was prepared in the following manner:

The methoxy groups of the silanes⁽³⁾⁽⁴⁾ were hydrolyzed by adding acid to a continuously stirred aqueous solution of this silane. The other constituents were then introduced, still with stirring, and the pH was adjusted to a value of 4±0.2, if necessary.

The weight content of solid matter in the sizing composition was equal to 9.9%.

The sizing composition was used to coat, in a known manner, E-glass filaments of about 12 μm in diameter drawn from streams of glass flowing from the holes in a bushing, the filaments being then gathered together in the form of packages of base strands having a linear density of 57 tex.

The package was then dried at 130° C. for 12 hours.

The base strands extracted from 6 packages were gathered together to form a roving.

The strand thus obtained had a loss on ignition equal to 1.4%.

Table 1 below gives the results of the measurements carried out on the strand according to the invention, denoted as example, and on a strand suitable for the LFI molding technique (sold by Owens Corning under the reference ME1020) coated with a size based on polyvinyl acetate, denoted by reference.

TABLE 1

| | Example | Reference |
|---|---|---|
| Number of loops/kg of strand | 40 | 60 |
| Fuzz (mg/kg of strand) | 11 | 12 |
| Half-charge decay time(s) | 1 | 2 |
| Integrity of the strand | 3.5 | 2.5 |
| Integrity of the chopped strand | 4.4 | 3 |

On reading table 1 it is observed that the strand from the example according to the invention has better properties than the reference strand with an equivalent amount of fuzz and equivalent half-charge decay time, namely that it has a lower number of loops and a better integrity before and after chopping.
(1) sold under the reference RHODOPAS® V1865 by Rhodia; solids content: 54%
(2) sold under the reference LUVISKOL® K90 by BASF; solids content: 20%
(3) sold under the reference SILQUEST® A-174 by GESM; solids content: 70%
(4) sold under the reference SILQUEST® A-1128 by GESM; solids content: 50%
(5) sold under the reference K-FLEX® 500 by Noveon; solids content: 100%
(6) sold under the reference EMERY® 6717 by Cognis; solids content: 100%.

1. A glass strand coated with an aqueous sizing composition, said sizing composition comprising an adhesive film-forming agent, said film-forming agent comprising a blend of at least one polyvinyl acetate (PVA) and at least one polyvinylpyrrolidone (PVP), wherein said at least one polyvinyl acetate represents 70 to 90% by weight of the solid matter of the size.

2. The glass strand as claimed in claim 1, further comprising a weight ratio of PVA to PVP between about 14 and 900.

3. The glass strand as claimed in claim 2 wherein the weight ratio of PVA to PVP is between about 18.75 and 106.25.

4. The glass strand as claimed in claim 1 wherein the PVA has a molecular weight less than about 80,000 g/mol

5. The glass strand as claimed in claim 4, wherein the PVA has a molecular weight less than about 70,000 g/mol

6. The glass strand as claimed in claim 5, wherein the PVA has a molecular weight between about 29,000 and 65,000 g/mol.

7. The glass strand as claimed in claim 1, wherein the PVP has a molecular weight less than or equal to about 4,000 g/mol.

8. The glass strand as claimed in claim 7, wherein the PVP has a molecular weight less than or equal to about 3,000 g/mol

9. The glass strand as claimed in claim 8, wherein the PVP has a molecular weight between about 1,000 and 2,000 g/mol.

10. The glass strand as claimed in claim 1, wherein the strand has a loss on ignition less than or equal to about 3%

11. The glass strand as claimed in claim 10, wherein the strand has a loss on ignition less than or equal to about 2%.

12. The glass strand as claimed in claim 11, wherein the strand has a loss on ignition between about 1.3 and 1.7%.

13. The glass strand as claimed claim 1
wherein the sizing composition comprises at least one plasticizer chosen from the derivatives of glycols, such as alkylene glycol dibenzoates.

14. The glass strand as claimed in claims 1, wherein the sizing composition further comprises at least one lubricant chosen from cationic compounds of the polyalkyleneimide type, and ionic compounds of the fatty acid and polyalkylene glycol polyoxyalkylene ester type or of the fatty acid and polyoxyalkylene amide type.

15. The glass strand as claimed claim 1, wherein the sizing composition further comprises at least one coupling agent chosen from silanes siloxanes titanates, zirconates and mixtures thereof.

16. The glass strand as claimed in claim 1, where in the sizing composition further comprises the constituents below, in the following weight contents expressed as percentages of solid matter:
70 to 90% of at least one PVA;
0.1 to 5% of at least one PVP;
6 to 20% of at least one plasticizer;
3 to 9% of at least one lubricant;
2 to 7% of at least one coupling agent; and
0 to 5% of at least one antistatic agent.

17. The glass strand as claimed in claim 16, where in the sizing composition further comprises the constituents below, in the following weight contents expressed as percentages of solid matter:
75 to 85%, of at least one PVA;
0.8 to 4%, of at least one PVP;
7 to 15%, of at least one plasticizer;
3.5 to 6.5%, of at least one lubricant;
3.5 to 6%, of at least one coupling agent; and
0 to 5% of at least one antistatic agent.

18. The glass strand as claimed in claim 17, where in the sizing composition comprises between 5 and 15% by weight of solid matter.

19. A glass strand as claimed in claim 18, where in the sizing composition comprises between 8 and 12% by weight of solid matter

20. A glass strand as claimed in claim 1, wherein said glass strand is capable of being combined with at least one thermosetting polymer material to form a composite part.

21. A glass strand as claimed in claim 1, wherein said glass strand is capable of being combined with at least one thermosetting polymer material selected from one of a polyester, a vinyl ester, an acrylic polymer, a polyurethane, a phenolic resin and an epoxy resin, to form a composite part.

22. A glass strand according to claim 21, wherein said glass strand is capable of being combined with at least one thermosetting polymer material in a ration to produce a composite part having a glass content between 20 and 45% by weight.

23. A glass strand according to claim 21, wherein said strand is capable of producing composites by the technique of spray-up molding, especially by the long fiber injection (LFI) technique.

24. A glass strand coated with an aqueous sizing composition, said sizing composition comprising an adhesive film-forming agent, said film-forming agent comprising a blend of at least one polyvinyl acetate (PVA) having a molecular weight less than about 80,000 g/mol and at least one polyvinylpyrrolidone (PVP) having a molecular weight less than or equal to about 4,000 g/mol, wherein said PVA and PVP are provided in a ratio of between about 14:1 and 900:1, and wherein said at least one PVA represents 70 to 90% by weight of the solid matter of the size.

25. The glass strand as claimed in claim 24, wherein the glass strand has a loss on ignition between about 1.3 and 1.7%.

26. The glass strand as claimed in claim 25, wherein the sizing composition comprises at least one plasticizer chosen from the derivatives of glycols, such as alkylene glycol dibenzoates.

27. The glass strand as claimed in claims 26, the sizing composition further comprising at least one lubricant chosen from cationic compounds of the polyalkyleneimide type, and ionic compounds of the fatty acid and polyalkylene glycol polyoxyalkylene ester type or of the fatty acid and polyoxyalkylene amide type.

28. The glass strand as claimed in claim 27, the sizing composition further comprising at least one coupling agent chosen from silanes, siloxanes, titanates, zirconates and mixtures thereof.

29. The glass strand as claimed in claim 28, where in the sizing composition further comprises the constituents below, in the following weight contents expressed as percentages of solid matter:
75 to 85%, of at least one PVA;
0.8 to 4%, of at least one PVP;
7 to 15%, of at least one plasticizer;
3.5 to 6.5%, of at least one lubricant;
3.5 to 6%, of at least one coupling agent; and
0 to 5% of at least one antistatic agent.

30. The glass strand as claimed in claim 29, where in the sizing composition comprises between 5 and 15% by weight of solid matter.

31. An aqueous sizing composition comprising an adhesive film-forming agent, said film-forming agent comprising a blend of at least one polyvinyl acetate (PVA) and at least one polyvinylpyrrolidone (POP), wherein said at least one polyvinyl acetate represents 70 to 90% by weight of the solid matter of the size.
